(19) United States
(12) Patent Application Publication
(10) Pub. No.: US 2023/0117602 A1
(43) Pub. Date: Apr. 20, 2023

(54) IMPROVEMENTS IN AND RELATING TO LOUDSPEAKER MAGNET ASSEMBLIES

(71) Applicant: B&W Group Ltd., Worthing (GB)

(72) Inventors: Martial Andre Robert Rousseau, Worthing (GB); Marco Baratelli, Worthing (GB)

(21) Appl. No.: 17/907,413

(22) PCT Filed: Mar. 30, 2021
(86) PCT No.: PCT/GB2021/050788

§ 371 Date: Sep. 27, 2022

(30) Foreign Application Priority Data
Apr. 1, 2020 (GB) 2004792.4

(51) Int. Cl. H04R 9/02; H04R 9/06; H04R 31/00

(52) U.S. Cl. CPC H04R 9/025; H04R 9/022; H04R 9/06; H04R 31/006; H04R 2209/021; H04R 2209/022; H04R 2209/024

(57) ABSTRACT

An ironless magnet assembly (128) for a loudspeaker (101) comprising two pairs of magnets (136) is disclosed. Each magnet (136) of each pair having a north pole and a south pole, a first pair of magnets (136c, 136d) are arranged with the north poles of the magnets of that pair facing each other and a second pair of magnets (136a, 136b) are arranged with the south poles of the magnets of that pair facing each other. The first pair of magnets (136c, 136d) are located opposite the second pair of magnets (136a, 136b) to define a voice coil gap (112) therebetween with each north pole of the first pair being located opposite a south pole of the second pair across the voice coil gap (112).

### FIELD OF THE INVENTION

The present invention concerns improvements in loudspeakers. More particularly, but not exclusively, this invention concerns a magnet assembly or motor for a loudspeaker. The invention also concerns a loudspeaker including such a magnet assembly and a method of manufacturing such a magnet assembly.

### BACKGROUND OF THE INVENTION

FIG. 1 shows a cross-sectional schematic view of a conventional loudspeaker 1. A loudspeaker diaphragm 2 (also known as a cone), is concentrically located within a chassis 4 (also known as a basket, frame or carrier). An annular surround 6 extends from the outer perimeter of the diaphragm 2 to the inner edge of the chassis 4.

A spider 20 is attached to, and extends between, a voice coil 10 mounted to the rear end of the diaphragm 2 and the chassis 4. A dust cap 22 covers a gap 24 in the centre of the diaphragm 2. The voice coil 10 extends rearwardly from the diaphragm 2 into a voice coil gap 12 formed between an annular magnet 14 and a central pole 16. The annular magnet 14 and central pole 16 are mounted on a magnetically conductive pole plate 26. A magnetically conductive annular top plate 18 is located on top of the annular magnet 14, between the annular magnet 14 and the chassis 4. Together, the annular magnet 14, central pole 16, pole plate 26 and top plate 18 may be referred to as a magnet assembly 28. Typically, annular magnet 14 is a permanent magnet while central pole 16, pole plate 26, and top plate 18 are made of soft magnetic material, for example ferromagnetic materials such as iron or steel.

In use an electrical current is applied to the voice coil generating a changing electromagnetic field which interacts with the magnetic field in the voice coil gap thereby generating at electromotive force on the voice coil causing the voice coil and consequently the diaphragm to move.

The strength of the magnetic field often varies significantly along the length of the voice coil gap in loudspeakers of the type shown in FIG. 1. This may lead to distortion in the sound produced by the drive unit as the force generated on the voice coil for a given current varies depending on the axial location of the voice coil in the voice coil gap. It would be advantageous to provide a drive unit in which this type of distortion is reduced and/or in which the level of such distortion can be better controlled.

One solution to this problem is to make the voice coil very much longer than the voice coil gap (an ‘overhung’ geometry). Alternatively, the voice coil may be made much shorter than the voice coil gap (an ‘underhung’ geometry). However both these solutions can lead to an increase in the size and/or mass of the drive unit and/or a reduction in the efficiency of the drive unit. Further, in loudspeakers of the type disclosed above, movement of the voice coil may generate eddy currents in the various elements made of soft magnetic materials, for example top plate 18, which may lead to distortion in the sound produced by the drive unit, particularly at high frequencies.

WO 2017/023485 discloses an example of a magnet assembly for a transducer including ferrous (i.e. soft magnetic) members that are used to contain and direct flux from the magnets. In the magnet assembly of WO 2017/023485 like poles of two magnets face each other on the same side of a voice coil gap, and opposite poles of two magnets face each other across the voice coil. The use of ferrous members may lead to distortion in the sound produced by a loudspeaker including the magnet assembly of WO2017/023458 as a result of the eddy currents generated in the ferrous material.

The present invention seeks to mitigate the above-mentioned problems. Alternatively or additionally, the present invention seeks to provide an improved drive unit for a loudspeaker.

### SUMMARY OF THE INVENTION

The present invention provides a magnet assembly for a loudspeaker comprising two pairs of magnets, each magnet of each pair having a north pole and a south pole. It may be that a first pair of magnets is arranged with the north poles of the magnets of that pair facing each other and a second pair of magnets is arranged with the south poles of the magnets of that pair facing each other. It may be that the first pair of magnets is located opposite the second pair of magnets thereby defining a voice coil gap between the two pairs of magnets. It may be that the magnets are arranged such that each north pole of the first pair is located opposite a south pole of the second pair. Each magnet may be a permanent magnet.

Thus, the present invention may provide four magnets, two on each side of the voice coil gap, with like poles facing each other on the same side of the gap and opposite poles facing each other across the gap. This arrangement may facilitate an improved magnetic field profile in the voice coil gap, for example a magnetic field profile with less variation along the length of voice coil gap. Additionally or alternatively, this arrangement may allow for a wider range of magnet field profiles to be achieved without the need for segmentation of the magnets and/or radial magnetisation. Thus, magnet assemblies in accordance with the present invention may be easier and/or more cost effective to manufacture than prior art magnet assemblies, for example prior art magnet assemblies capable of providing similar magnetic fields.

The magnets of each pair may be arranged to repel (e.g. exert a repulsive force on) each other. That is to say, each magnet of a pair may experience a repulsive force due to the presence of the other magnet of the pair. The magnets of each pair may be spaced apart from each other along the longitudinal axis of the voice coil gap. The magnets of each pair may be immediately adjacent magnets. That is to say, it may be that no permanent magnet is located in between the magnets of a pair.

It may be that the magnets of each pair are located immediately adjacent each other, for example touching each other (excluding any adhesive used to bond the two magnets together, if present), for example without any intervening components. It may be that non-magnetic material, for example a spacer plate, is located between two magnets of a pair.

The operational region of the voice coil gap may be defined as the length of the voice coil gap in which the winding of the voice coil moves (i.e. the region between the points of maximum forward and backward excursion from the position occupied by the voice coil when not being driven) during normal operation.

It may be that the width (for example the radial extent) of the voice coil gap defined between the two pairs of magnets varies along the length of the voice coil gap. It may be that the width of the voice coil gap varies along the length of the operational region of the voice coil gap.

Providing a voice coil gap having a width that varies along its length (for example by using a first surface as discussed below) may allow the magnet field profile to be tailored to a particular application. In some applications, such variation may be used to provide a more even distribution of magnetic field in the gap.

Each magnet of the first and second pairs may comprise a first surface that is neither parallel nor perpendicular to the longitudinal axis of the voice coil gap. It may be that the magnets are arranged such that the first surfaces of the magnets together define (wholly or in part) an enlarged region of the voice coil gap. For example, it may be that each magnet is arranged with its first surface at the innermost corner region of the magnet. The innermost corner region of the magnet may be defined as the region closest to both of the other magnet of that pair and the opposing magnet of the other pair. It may be that the enlarged region and the operational region are wholly or partially overlapping. It may be that the enlarged region and the operational region are coincident.

It may be that the voice coil gap comprises a first region in which the gap between the first and second pairs of magnets has a first width, a second (or enlarged region) in which the gap between the first and second pairs of magnets has a second width, and a third region in which the gap between the first and second pairs of magnets has a third width, the second region being located between the first and third regions, the second width being greater than the first and third widths. Thus, the second region may be an enlarged region. The width of the second region may be at least twice, for example at least three times the width of the first and/or second regions.

It may be that each first surface is shaped, for example inclined, such that when the magnets are arranged as described above magnetic flux flows in a direction substantially perpendicular to the longitudinal axis of the voice coil gap.

It may be that each first surface is shaped, for example inclined, such that when the magnets are arranged as described above the magnetic field varies by less than 10 percent, for example less that 5 percent, along the length of the operational region. It may be that each first surface is shaped, for example inclined, such that when the magnets are arranged as described above the magnetic field strength is substantially constant along the length of the operational region of the voice coil gap.

It will be appreciated that the more parallel the flux lines across the voice-coil gap the more efficient the use of magnet volume will be. However, the design intent may be to achieve a magnetic field profile and not to optimise for efficient use of the magnet.

The magnets of each pair may be symmetrical about a first plane of symmetry, for example a radially extending plane. The enlarged region and/or the operational region may extend either side of the first plane of symmetry, for example be centred on the first plane of symmetry.

For each magnet, a first notional plane may be defined that faces the opposing magnet of the other pair (the magnet on the opposite side of the voice coil gap). The first notional plane of a magnet may extend parallel to the longitudinal axis of that magnet. The first notional plane may be located immediately adjacent the surface of that magnet that is closest to the opposing magnet.

For each magnet, a second notional plane may be defined that faces the other magnet of the pair (the magnet on the same side of the voice coil gap). The second notional plane of a magnet may extend perpendicular to the longitudinal axis of that magnet. The second notional plane may be located immediately adjacent the surface of that magnet that is closest to the other magnet of the pair.

In some cases, for example where the magnet has a polygonal shape when viewed in cross-section, the first and/or second notional plane may be coincident with a first and/or second side of the magnet respectively. Thus, a first side of a magnet may be defined as the side of the magnet facing the opposing magnet of the other pair. Similarly, a second side of a magnet may be defined as the side of the magnet facing the other magnet of the pair. Properties and features described herein with reference to the notional plane may apply to the relevant side and vice versa, except where such features and properties are clearly incompatible.

A first surface of each magnet may extend between the first and second notional planes thereby defining an enlarged region of the voice coil gap. An enlarged region of the voice coil gap may be defined as a portion of the voice coil gap which (when viewed in cross-section) has a width that is greater than the minimum distance between opposing magnets (the radial distance between the closest points of two magnets located on either side of the voice coil). The first surface of each magnet may define (at least in part) an enlarged region of the voice coil gap, for example in combination with the first surfaces of the other magnets. Thus, the enlarged region of the voice coil gap may be defined by four first surfaces, one for each magnet. Each first surface may be shaped such that flux between the magnets is substantially parallel to the longitudinal axis of the voice coil and/or magnets in the enlarged region. Each first surface may be shaped such that magnetic field provides a target profile across the voice coil gap. Each first surface may be shaped such that magnetic field strength is substantially constant over the majority, for example the whole, of the length of the operational region.

It may be that each magnet comprises a first surface that defines the voice coil gap but which is neither perpendicular nor parallel thereto. Providing such a surface may facilitate the provision of a magnetic field that varies less along the length of the voice coil gap and/or operational region, for example that is substantially constant along the length of the voice coil gap and/or operational region. Additionally or alternatively, using a shaped first surface may facilitate the provision of a magnetic field having a desired magnetic field profile across the voice coil gap. Additionally or alternatively, using a shaped first surface may facilitate the provision of a magnetic field of a given strength using smaller magnets than prior art solutions.

The cross-sectional shape of the first surface (i.e. the shape of the first surface when viewed in cross-section) may be defined by a line. The line may comprise a straight portion. Thus, at least part of the line may be straight. At least a portion of the first surface may be planar. The line may comprise a diagonal line extending away from the first notional plane towards the second notional plane. The line may comprise a diagonal line extending from the first notional plane towards, for example to the second notional plane (or vice versa).

The line, for example a straight portion of the line, may be inclined at an angle of between 5 and 85 degrees, for example between 20 and 70 degrees, for example between 40 and 50 degrees, for example around 45 degrees, with respect to the second notional plane.

The majority of the length of the line, for example the whole of the length of the line may be substantially straight. Thus, each magnet may comprise a chamfer, for example on the innermost corner of the magnet. For example each surface may comprise a chamfer connecting the first and second notional planes.

A magnet shaped to have a straight first surface, for example a chamfered corner, may be an effective way of providing a desired magnetic field profile in the voice coil gap, for example a substantially constant field and/or flux lines substantially perpendicular to the longitudinal axis of the voice coil gap while being relatively easy to manufacture. For example, the materials from which some magnets (for example rare-earth magnets) are made may be brittle and/or hard to machine placing limits on the type and complexity of geometry that can be cost-effectively manufactured.

The line may comprise a curve. Thus, at least part of the line may be curved. The curve may comprises a curve of constant or varying radius. The curve may extend away from the first notional plane towards the second notional plane (or vice versa). The curve may extend between the first and second notional planes.

The majority of the length of the line, for example the whole of the length of the line may be curved, for example may be a curve of constant radius. Thus, each magnet may comprise a rounded corner, for example a rounded corner connecting the first and second notional planes.

The first surface may have a more complex shape when viewed in cross-section. The line may comprise one or more straight portions and/or one or more curved portions in combination. The line may comprise a first straight portion and a second straight portion. It may be that the second straight portion is inclined with respect to the first straight portion. The first straight portion may be inclined at a first angle with respect to the second notional plane, the second straight portion may be inclined at a second angle with respect to the second notional plane. The first and second angles may be the same of different. The line may comprise a first curve, for example a convex or concave curve. The line may comprise a second curve, for example a convex or concave curve. The type (i.e. convex or concave), amplitude and/or frequency of the first and second curve may be the same or different.

The length of the line defining the first surface may be at least 10 percent, for example at least 20 percent, for example at least 50 percent of the length of the first and/or second sides. The line may be longer than the length of the first and/or second sides.

The maximum distance (for example radial distance) between opposing first surfaces defining the enlarged region may be at least twice, for example at least four times, the height of the coil and/or the length of the operational region. The enlarged region may be sufficiently large so as to accommodate therein a notional circle having a radius least twice, for example at least four times, the length of the operational region. The notional circle when received within the enlarged region may be centred on a point located on the first plane of symmetry and/or the centreline of the voice coil gap.

It may be that one of the first or second pair of magnets is concentrically located within the other of the first or second pair of magnets. It may be that the first and/or second pair of magnets comprises two annular magnets. One pair of magnets, for example the first pair of magnets, may be concentrically located within the other pair of magnets, for example the second pair of magnets. The magnets of the first and/or second pair may comprise two ring-shaped magnets. The magnets of the first and/or second pair may comprise two conical magnets, for example each magnet may comprise a truncated cone, optionally having a central bore extending therethrough.

It may be that each magnet is a permanent magnet or rare-earth magnet, for example a magnet comprising Neodymium (NdFeB), Samarium-cobalt (SmCo), and/or hard ferrites, for example ceramic materials, for example Strontium ferrite (SrFeO) and/or Barium ferrite (BaFeO). The higher magnetic strength of such magnets may be of particular application in drive units in accordance with the present invention.

It may be that each magnet is a dipole magnet. Thus each magnet may have only two poles, for example a single north pole and a single south pole.

It may be that a spacer is located in between the two magnets of the first pair and/or the second pair. The spacer may comprise a plate, for example an annular plate. The spacer may comprise a first edge and a second edge, the first edge being located radially closer to the voice coil gap than the second edge. The first edge may comprise one or more protrusions extending away, for example forward and/or rearwardly, from the plate. Each protrusion may occupy at least a portion of the space bounded by the intersection of the first and second notional planes and the first surface. The protrusion(s) may occupy the whole of the space between the intersection of the first and second notional planes and the first surface. The spacer may comprise one of more protrusions extending around the majority of, for example the whole of, the perimeter of the spacer. The magnets may be immediately adjacent the spacer, for example directly contacting the spacer (excluding any adhesive used to bond the magnets to the spacer, if present). That is to say, it may be that no components are located between the magnets and the spacer.

It may be that the spacer comprises, consists essentially of, consists of or is made from a thermally conductive material such that the spacer conducts heat away from the magnets between which it is located.

It may be that the spacer comprises, consists essentially of, consists of or is made from an electrically conductive material such that the spacer acts to reduce inductive distortion in the voice coil.

The spacer may comprise, consist essentially or, consist of or be made from non-magnetic material, for example Aluminium.

The magnet assembly may comprise a heat sink in thermal communication with one or more of the magnets. The spacer may be in thermal communication with the heat sink such that heat conducted away from the magnets can be dissipated in the heat sink.

The magnet assembly may comprise a pole plate, for example a radially extending pole plate. The rearward magnet of the first and/or second pair may be mounted on the pole plate.

The magnet assembly may comprise a support, one or more of the magnets, for example all of the magnets being mounted on the support. The or each spacer may form part of the support. Thus, the support may comprise one or more spacers as described above. The support may comprise a pole plate as described above. The support may comprise one or more walls extending vertically, for example forward, from the pole plate. One or more of the magnets may be mounted on the wall(s).

A magnet may be mounted on the support (or any element thereof) by bonding the magnet to the support, for example using an adhesive.

The support, for example the pole plate, spacer and/or wall, may comprise, consist essentially of, consist of, and/or be made from a non-magnetic material, for example material having a magnetic permeability similar to that of the fluid in the voice coil gap, for example similar to air. Using such a material may reduce the impact of the support on the magnetic field. Thus, the magnet assembly may be an ironless magnet assembly. An ironless magnet assembly (or drive unit or loudspeaker may be defined as a magnet assembly (or drive unit or loudspeaker) that does not comprise ferromagnetic parts, for example parts made of iron or soft magnetic materials, configured to direct magnetic flux across the voice coil gap. An ironless magnet assembly may be configured such that the magnetic field pattern in the voice coil gap is substantially determined by the permanent magnets of the magnet assembly.

Materials may be classified as either magnetic materials or non-magnetic (or non magnetically-conductive) materials. Magnetic materials may be further classified as hard magnetic materials (e.g. permanent magnets) and soft magnetic materials. Soft magnetic materials can be magnetized but do not tend to stay magnetized, accordingly soft materials will become magnetized and generate flux in the presence of a magnet field. Soft magnetic materials include the ferrous metals, for example iron and/or alloys thereof for example steel. The magnet assembly may be an ironless magnet assembly. That is to say, the magnet assembly, excluding the magnets themselves but including for example the pole plate and/or top plate, comprises, consists of, and/or is made essentially of non-magnetic material. It will be appreciated that in an ironless magnet assembly the magnets themselves may include iron, for example where the magnets comprise Neodymium (NdFeB). The term “ironless” in the context of loudspeakers is well understood by the skilled person. The magnet assembly may comprise a plate of electrically conductive material, for example a copper plate, mounted on the first and/or second pair of magnets to extend along a portion, for example the majority or the whole, of the length of the operative region of the voice coil gap. The plate may be curved. The plate may extend around a portion of, for example the majority or the whole of, the perimeter of one of the pairs of magnets. Thus, the magnet assembly may comprise a whole or partial sleeve of electrically conductive material mounted on one of the pairs of magnets adjacent the voice coil gap.

The electrically conductive plate and the voice coil may have a reduced inductance in comparison to the coil without the plate. Accordingly, the presence of the electrically conductive plate may reduce distortion in the sound produced by a loudspeaker having such a magnet assembly.

The magnets may be symmetrical rotationally about the longitudinal axis of the drive unit and/or about the first plane of symmetry.

The voice-coil gap may comprise a fluid-filled (for example air-filled) void in which the voice coil can move. Any structure on which the magnets are mounted may have a similar magnetic permeability to the fluid in the void, for example air. Thus, any structure on which the magnets are mounted may be made of non-magnetic materials.

The present invention may find application across drive units of all sizes, but may find particular application in low frequency drive units (woofers or bass drivers) operating at frequencies between 20 Hz and 500 Hz and/or medium-low drive units (mid woofers) operating at frequencies between 20 Hz and 5000 Hz.

The magnets may have a length (extent along the longitudinal axis of the voice coil gap) of between 5 and 50 mm, for example between 15 and 25 mm.

The voice coil gap may have a minimum width of at least lmm. The voice coil gap may have a maximum width of up to 50 mm, for example up to 25 mm.

In the case that a pair of magnets is concentrically located within the other pair of magnets, the outer surface of the inner pair of magnets may have a minimum radius of 4 to 8 mm in the region of the voice coil gap. The outer surface of the inner pair of magnets may have a maximum radius of 12 to 16 mm in the region of the voice coil gap. The inner surface of the outer pair of magnets may have a maximum radius of 20 to 24 mm in the region of the voice coil gap. The inner surface of the outer pair of magnets may have a minimum radius of 14 to 18 mm in the region of the voice coil gap.

The drive unit may comprise a diaphragm. The drive unit may comprise a voice coil located in the voice coil gap. The voice coil may be mounted on the diaphragm for movement therewith. The voice coil may comprise a former (also known as a bobbin). The voice coil may comprise a winding, for example a coil of wire, arranged to conduct current.

In a second aspect of the invention there is provided a drive unit for a loudspeaker comprising a magnet assembly in accordance with any other aspect of the invention.

In a third aspect of the invention there is provided a loudspeaker comprising a magnet assembly and/or drive unit in accordance with any other aspect. The magnet assembly and/or drive unit may be mounted in a loudspeaker enclosure, for example to form a loudspeaker for a hi-fi system.

In a fourth aspect of the invention there is provided a method of manufacturing a magnet assembly for a loudspeaker. The method may comprise arranging a plurality of magnets to provide one or more of a first pair of magnets wherein the force generated between the poles of the magnets of the first pair acts to repel the magnets from each other, for example with like poles facing each other and a second pair of magnets wherein the force generated between the poles of the magnets of the second pair acts to repel the magnets from each other, for example with like poles facing each other. The method may comprise arranging the plurality of magnets to define a voice coil gap there between and/or so that the force generated between the poles of the first pair and the poles of the second pair acts to attract the magnets to each other, for example with poles of different polarity opposite each other.

The method may comprise arranging the magnets in the first and second pairs and then arranging the first and second pair of magnets to define the voice coil gap there between. Alternatively, the method may comprise arranging at least two magnets to provide a voice coil gap, and then adding one or more magnets to the arrangement to form the first and second pairs.

The step of arranging the first and/or second pair of magnets to repel each other may comprise mounting the magnets of a pair on either side of a spacer. The step of arranging the first and/or second pair of magnets to repel each other may comprise mounting the magnets of a support, for example on a pole plate, wall of space. Such a method may further comprise bonding the magnets to the support, pole plate and/or spacer.

The step of arranging the first and/or second pair of magnets to repel each other may comprise bonding the magnets of the first pair and/or the second pair to each other, for example using an adhesive.

The method may comprise shaping each magnet to provide a first surface. The method may comprise arranging each magnet such that the first surfaces of the magnets together define an enlarged region of the voice coil gap.

The step of shaping a magnet may comprise additively manufacturing a magnet, for example sintering, for example laser sintering, a powder to form a magnet.

The step of shaping a magnet may comprise comprises removing material from a magnet, for example by grinding and/or cutting, to produce the first surface, for example to produce a chamfered or rounded corner.

It may be that the method comprises modifying the design of the first surfaces of the magnets to obtain a target magnetic field profile in the voice coil gap. The step of modifying the design may comprise providing an original first surface design for each of the magnets, the first surface design producing a magnetic field profile in the voice coil gap that differs from the target design. The method may comprise modifying the original first surface design, for example modifying the shape of the first surface, for example the shape of the line that defines the cross-sectional shape of the first surface, in order to produce a modified design that provides the target magnetic field profile in the voice coil gap. Modifying the design may comprise increasing and/or decreasing the angle of a straight portion of the line with respect to the second notional plane. Modifying the design may comprise adding and/or removing one or more straight and/or curved portions from the line. The method may comprise making a drive unit to the modified design.

Thus, by altering the shape of the first surface the present invention may facilitate the ‘tuning’ of the magnetic field profile to provide a desired magnetic field profile (for example strength and/or shape) in the voice coil gap. The target magnetic profile may comprise flux flowing substantially perpendicular to the longitudinal axis of the voice coil gap, for example in the operational region. The target magnet profile comprise substantially constant magnetic field strength in the voice coil gap, for example across the operational region.

It will of course be appreciated that features described in relation to one aspect of the present invention may be incorporated into other aspects of the present invention. For example, the method of the invention may incorporate any of the features described with reference to the apparatus of the invention and vice versa.

### DESCRIPTION OF THE DRAWINGS

Embodiments of the present invention will now be described by way of example only with reference to the accompanying schematic drawings of which:

FIG. 1 shows a cross-sectional view of a conventional loudspeaker;

FIG. 2 shows a cross-sectional perspective view of part of a drive unit according to a first example embodiment of the invention;

FIG. 3 shows a close up view of part of the magnet assembly of FIG. 2;

FIG. 4 shows flux lines in the magnet assembly of FIG. 2;

FIG. 5 shows a close up view of part of a magnet assembly in accordance with a second example embodiment of the invention;

FIG. 6 shows flux lines in part of a magnet assembly in accordance with a third example embodiment of the invention;

FIG. 7 shows a close up of part the magnet assembly of FIG. 6; and

FIG. 8 shows an example method of manufacturing a magnet assembly.

### DETAILED DESCRIPTION

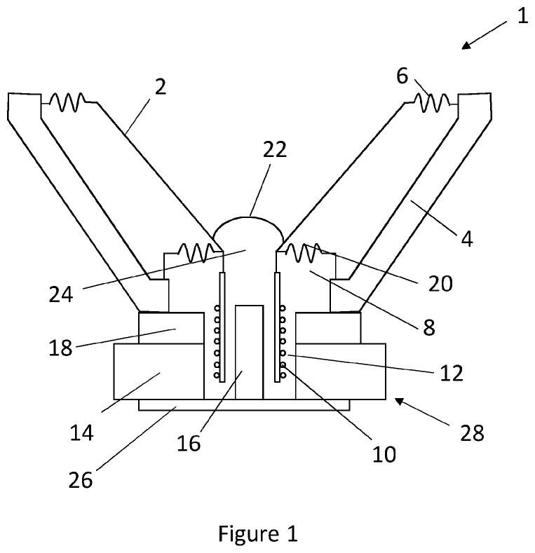

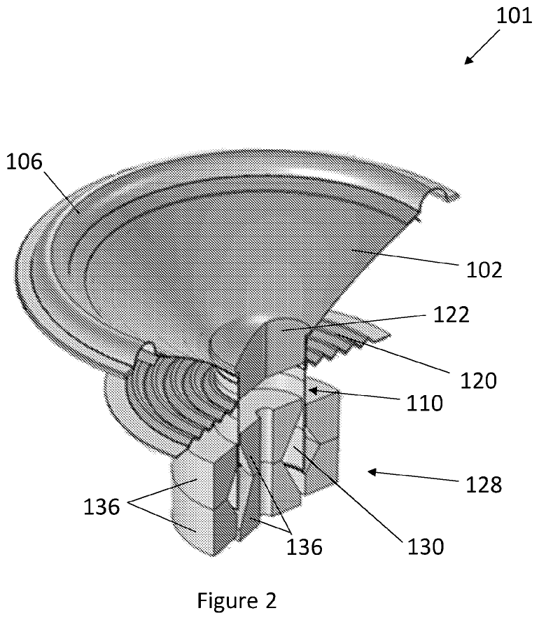

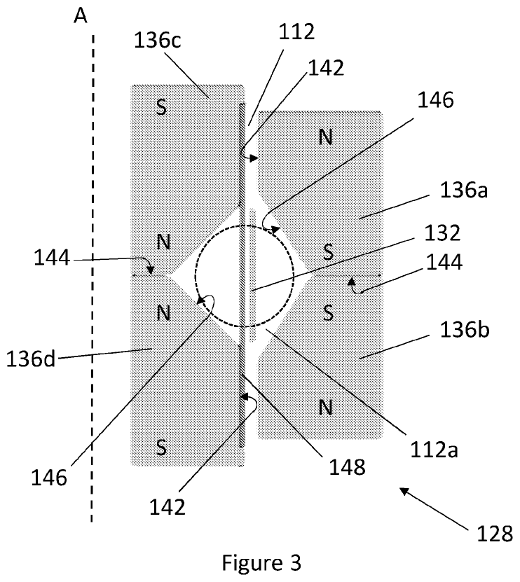

FIG. 2 shows a cross-sectional view of part of a loudspeaker assembly 101 in accordance with a first example embodiment of the invention. Elements that are similar as between FIGS. 1 and FIG. 2 have been indicated in FIG. 2 using their reference numeral from FIG. 1 incremented by 100 (i.e. spider 20 in FIG. 1 is referred to as spider 120 in FIG. 2). FIG. 2 shows a diaphragm 102, connected to a half roll surround 106. For clarity, the chassis has been omitted from FIG. 2, but it will be understood that the outer perimeter of the surround 106 would be connected to the chassis. A dust cap 122 is located at the centre of the diaphragm 102. A voice coil 110 comprising a cylindrical voice coil former 130 having a coil 132 (see FIG. 3) wound around it extends downwardly from the centre of the diaphragm 102 in a voice coil gap 112 formed between four magnets 136. Two of the magnets, labelled 136a, 136b in FIG. 3 are annular and form a pair with an upper annular magnet 136a being located on top of a lower annular magnet 136b. Two of the magnets, labelled 136c, 136d in FIG. 3 are conical and form a paid with an upper conical magnet 136c being located on top of a lower conical magnet 136d. The conical magnets 136c, 136d are concentrically located within the annular magnets 136a, 136b, the voice gap 112 being the annular gap formed between them. A spider 120 in the form of a corrugated disk extends from the voice coil former 130 to the chassis (not shown). It will be appreciated that the present invention is concerned with the arrangement of the magnets 136 and the shape and configuration of other elements of the loudspeaker, e.g. the shape and configuration of the diaphragm 102, support 106, voice coil 110 and/or spider 120, may differ from that shown here. Additionally or alternatively, some elements shown here, for example dust cap 122 may be absent in other embodiments of the present invention. Magnets 136 are Neodymium (NdFeB) magnets produced by laser sintering material in powdered form and then grinding to shape and form magnet assembly 128. The drive unit of FIG. 2 is an ironless drive unit—there are no soft magnetic materials arranged to control the flux of the magnetic field. In other embodiments NdFeB magnets produced by other manufacturing processes may be used. In yet further embodiments, the magnets may be made of any permanent magnet material, for example Samarium-cobalt (SmCo), and/or hard ferrites, for example ceramic materials, for example Strontium ferrite (SrFeO) and/or Barium ferrite (BaFeO). In yet further embodiments, the drive unit may be non-ironless, for example ferromagnetic materials, for example iron or steel may be used for the magnets. The pairs of magnets 136a, 136b and 136c, 136d are directly bonded together using an adhesive.

FIG. 3 shows a cross-sectional close up of part of the loudspeaker assembly of FIG. 2. The line of symmetry of the loudspeaker assembly of FIG. 2 is indicated by a dashed line labelled A in FIG. 3. The north and south poles of each magnet are indicated with an N or S respectively in FIG. 3. As shown in FIG. 2, the two conical magnets 136c, 136d are arranged with their north poles immediately adjacent to and facing each other. The two annular magnets 136a, 136b are arranged with their south poles immediately adjacent to and facing each other. In other embodiments, the polarities may be reversed, i.e. the south poles of the conical magnets 136c, 136d facing each other and the north poles of the annular magnets 136a, 136b facing each other. The conical magnets 136c, 136d are located opposite the annular magnets 136a, 136b such that each south pole of an annular magnet 136a, 136b is vertically aligned with a south pole of a conical magnet 136c, 136d. A first side 142 of each magnet faces the voice gap 112. A second side 144 of each magnet faces the other magnet 136 of the same type (i.e. conical or annular). The first side 142 is approximately perpendicular to the second side 144. The first side 142 and second side 144 are joined by a third, straight, side 146 extending between them; thus the corner between the first side 142 and second side 144 may be said to be chamfered. The chamfering creates an enlarged region 112a of the voice coil gap 112. The voice coil 110 is located in this enlarged region 112a in FIG. 3. The first side 142 and third side 144 of a magnet 136 may be said to form a surface defining at least a portion of the voice coil gap 112. In other embodiments, the third side 146 may not be straight and/or diagonal, for example in some embodiments the third side 146 may be curved or have a complex geometry. A notional circle, denoted by dashed line B in FIG. 3, is shown in the enlarged region 112a of the voice coil gap 112. The radius of the notional circle B is more than twice the maximum distance moved by the voice coil 110 during normal operation—that is the longitudinal distance between the point foremost (or uppermost as shown in FIG. 3) and rearmost (of lowest as shown in FIG. 3) point of travel of the coil 132 during normal operation.

A copper sleeve 148 extends along one side of the voice coil gap 112 from the first side 142 of the upper conical magnet 136c to the first side 142 of the lower conical magnet 136d.

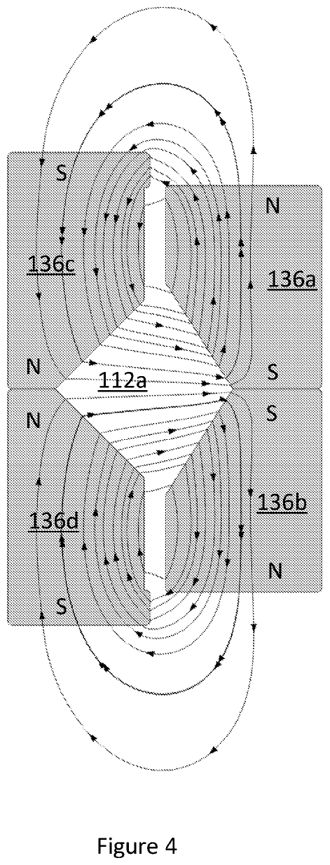

FIG. 4 shows flux lines in and around the magnets 136 of FIG. 3. In the enlarged region 112a of the voice coil gap 112 the flux lines are fairly evenly spaced and substantially perpendicular to the axis of movement of the voice coil 110. Consequently, the magnetic field density is substantially constant in the enlarged region 112a. Accordingly, loudspeakers in accordance with the present example embodiment may provide improved sound reproduction as a consequence of reduced nonlinearity in the force experienced by the voice coil as it moves in the voice coil gap. Additionally or alternatively, use of the shaped e.g. chamfered edges in accordance with the present example embodiment allows a designer to shape the magnetic flux in the air gap to obtain a desired force factor behaviour. Additionally or alternatively, use of the shaped e.g. chamfered edges in accordance with the present embodiment may allow for a reduction in the size of magnets required allowing for a reduction in loudspeaker size and/or weight.

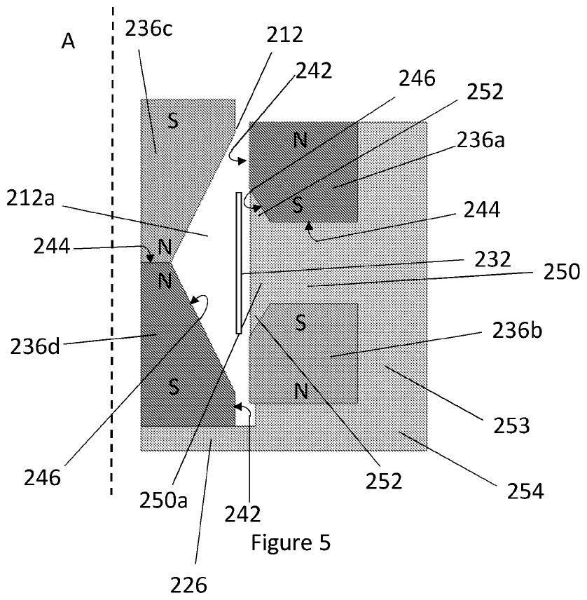

FIG. 5 shows a cross-sectional close up of part of a loudspeaker assembly in accordance with a second example embodiment. Elements that are similar as between FIGS. 3 and FIG. 5 have been indicated in FIG. 5 using their reference numeral from FIG. 3 incremented by 100 (i.e. magnet 136 in FIG. 3 is referred to as magnet 236 in FIG. 5). The arrangement of FIG. 5 is substantially as described in FIG. 3, with the exception that a spacer plate 250 is located in between the two annular magnets 236a, 236b. The inner end 250a of the spacer plate 250 (the end adjacent the voice coil gap 212) comprises projections 252 that fill the space created by the chamfered corners of the annular magnets 236a, 236b so that together the surfaces of the annular magnets 236a, 236b and distal end 250a facing the voice coil gap 212 form a straight line. Spacer plate 250 extends radially outward to an upwardly extending wall 253 that along with pole plate 226 forms a cup 254 around the magnets 236. Conical magnets 236c, 236d are mounted on pole plate 226. Spacer plate 250, wall 252 and pole plate 226 are made from Aluminium. Accordingly, the loudspeaker assembly of the second example embodiment may be described as an ‘ironless’ loudspeaker. In other embodiments, different material may be used. However, use of materials having a magnetic permeability similar to that of the fluid in the voice coil gap (for example Air) may reduce the impact of the cup on the magnetic field.

Spacer plate 250 conducts heat away from magnets 236, accordingly loudspeakers in accordance with the present embodiment may have improved heat dissipation. Heat from spacer plate 250 may be dissipated by airflow over cup 254. Additionally or alternatively, loudspeakers in accordance with the present embodiment may be easier to manufacture as spacer plate 250 provides an increased gluing area and facilitates arranging the magnets 236 with like poles adjacent (i.e. in a configuration in which the magnets 236 repel each other).

In other embodiments, not shown, a spacer plate may be provided between the two conical magnets. This may be in addition to or instead of the spacer plate provided between the two annular magnets.

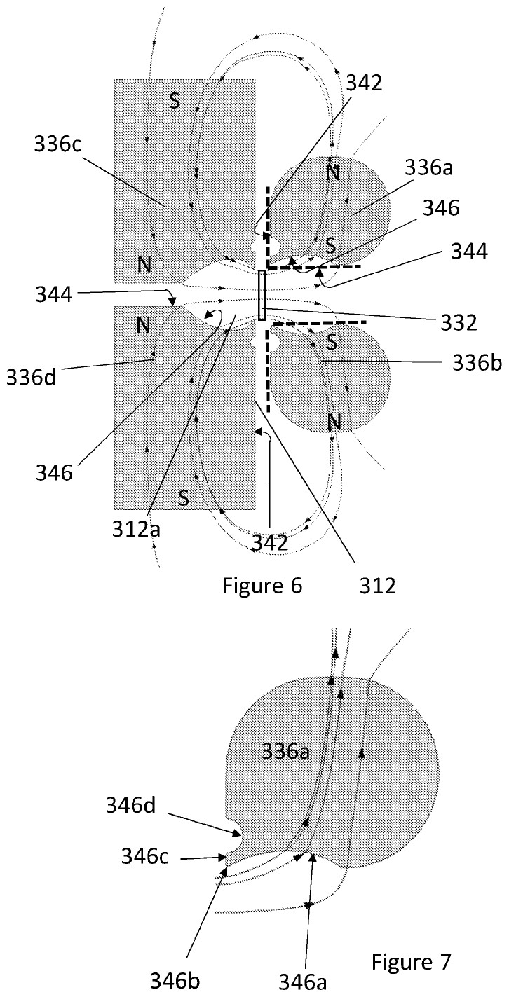

FIG. 6 shows flux lines in and around the magnets 336 of a loudspeaker in accordance with a third example embodiment. Elements that are similar as between FIG. 5 and FIG. 6 have been indicated in FIG. 6 using their reference numeral from FIG. 5 incremented by 100 (i.e. magnet 236 in FIG. 5 is referred to as magnet 336 in FIG. 6). A spacer plate (not shown in FIG. 6) is located between each pair of magnets 336. In the third example embodiment the shape of the magnets 336 is more complex in comparison to the straight-line geometry of the previous embodiments. Away from the location of the voice coil 310 as shown in FIG. 6 the inner pair of magnets 336c, 336c are substantially rectangular when viewed in cross-section with a first side 342 facing the voice coil gap 112/outer pair of magnets 336a, 336b and a second side 344 facing the other magnet of the pair (i.e. the other inner magnet 336c or 336d). However, the surface 346 extending between the first side 342 and the second side 344 comprises, when viewed in cross-section, in order from the second side 344 to the first side 342, a first curve 346a, a corner 346b, a straight portion 346c and a second curve 346d (shown in more detail in FIG. 7). The inner pair of magnets 336c, 336d are symmetrical about a horizontal plane. Away from the location of the voice coil 310 as shown in FIG. 6 the outer pair of magnets 336a, 336b are substantially oval when viewed in cross-section with a the first side 342 being a notional first side 342 facing the voice coil gap 112/inner pair of magnets 336c, 336d and a second side 344 being a notional second side 344 facing the other magnet of the pair (i.e. the other outer magnet 336a or 336b). Notional first side 342 and second side 344 of the outer pair of magnets 336a, 336b are shown by dashed lines in FIG. 6. The surface 346 extending between the first side 342 and the second side 344 of each magnet 336a, 336b of the outer pair, when viewed in cross-section, in order from the second side 344 to the first side 342, a first curve 346a, a corner 346b, a straight portion 346c and a second curve 346d. However the radius and length of the curves differs as between the inner magnets 336c, 336d and the outer pair of magnets 336a, 336b, giving a different profile for two pairs of magnets. The outer pair of magnets 336a, 336b are symmetrical about a horizontal plane. A first enlarged region 112a of the voice coil gap 112 is defined by the first curves 346a of the magnets 336. Second 112b and third 112c enlarged regions of the voice coil gap are defined by the second curves 346d of the magnets 336 and are located either side of the first enlarged region 112a along the length of the voice coil gap 112. The voice coil gap 112 is symmetrical about a horizontal plane. The Neodymium magnets 336 are mounted on spacer plates and supporting structure (not shown in FIG. 6) made of Aluminium using adhesive. In other embodiments, different materials may be used for the magnets, space plates and/or supporting structure.

In and between the three enlarged regions 312a of the voice coil gap 312 the flux lines are fairly evenly spaced and substantially perpendicular to the axis of movement of the voice coil 310. Consequently, the magnetic field density is substantially constant in the portion of the voice coil gap 312 occupied by the voice coil 310 during normal operation. Accordingly, loudspeakers in accordance with the present example embodiment may provide improved sound reproduction as a consequence of reduced nonlinearity in the force experienced by the voice coil as it moves in the voice coil gap. Additionally or alternatively, use of the shaped edges in accordance with the present example embodiment allows a designer to shape the magnetic flux in the air gap to obtain a desired force factor behaviour. Additionally or alternatively, use of the shaped e edges in accordance with the present embodiment may allow for a reduction in the amount of magnetic material required to achieve a particular magnetic flux profile thereby allowing for a reduction in loudspeaker size, weight and/or cost.

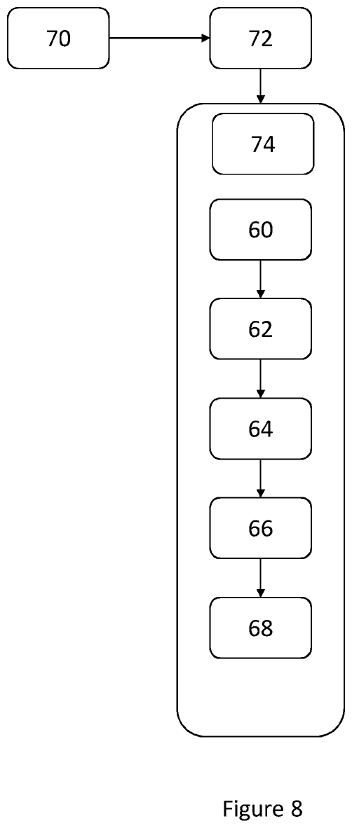

FIG. 8 shows a flow chart of an example method of manufacturing a magnet assembly in accordance with the present invention. The method comprises building up 60 each permanent magnet by laser sintering a powdered material. The method comprises grinding 62 each magnet to produce a chamfered edge, as described above. In other embodiments other additive manufacturing processes may be used in isolation or in combination with subtracting manufacturing processes to produce magnets as described in any of the above example embodiments. The method comprises bonding 64 the north poles of a first pair of magnets together using an adhesive. The method comprises bonding 66 the south poles of a second pair of magnets together using an adhesive. In other embodiments the magnets may not be directly bonded together, but may instead be bonded and/or otherwise mounted to a support structure. The method may comprise arranging 68 the first pair of magnets opposite the second pair of magnets to provide a voice coil gap, with each north pole opposing a south pole across the gap.

In some embodiments, the method may comprise providing 70 an original design for a drive unit. The method may comprise modifying 72 the shape of the first surface of the magnets of the original design to provide a target magnetic field in the voice coil gap. The method may then comprise making 74 a magnet to the modified design that method optionally including the steps discussed above.

Whilst the present invention has been described and illustrated with reference to particular embodiments, it will be appreciated by those of ordinary skill in the art that the invention lends itself to many different variations not specifically illustrated herein.

Where in the foregoing description, integers or elements are mentioned which have known, obvious or foreseeable equivalents, then such equivalents are herein incorporated as if individually set forth. Reference should be made to the claims for determining the true scope of the present invention, which should be construed so as to encompass any such equivalents. It will also be appreciated by the reader that integers or features of the invention that are described as preferable, advantageous, convenient or the like are optional and do not limit the scope of the independent claims. Moreover, it is to be understood that such optional integers or features, whilst of possible benefit in some embodiments of the invention, may not be desirable, and may therefore be absent, in other embodiments.

1. An ironless magnet assembly for a loudspeaker comprising
two pairs of magnets, each magnet of each pair having a north pole and a south pole, a first pair of magnets being arranged with the north poles of the magnets of that pair facing each other and a second pair of magnets being arranged with the south poles of the magnets of that pair facing each other;
the first pair of magnets being located opposite the second pair of magnets to define a voice coil gap therebetween with each north pole of the first pair being located opposite a south pole of the second pair across the voice coil gap.

2. A magnet assembly according to claim 1, wherein the width of the voice coil gap defined between the two pairs of magnets varies along the length of the voice coil gap.

3. A magnet assembly according to claim 2, wherein each magnet comprises a first surface that is neither parallel nor perpendicular to a longitudinal axis of the voice coil gap, the first surfaces of the magnets together defining an enlarged region of the voice coil gap.

4. A magnet assembly according to claim 3, wherein for each magnet,
a first notional plane may be defined that faces the opposing magnet of the other pair; and
a second notional plane may be defined that faces the other magnet of the pair;
and
the first surface extends between the first and second notional planes thereby defining the enlarged region of the voice coil gap.

5. A magnet assembly according to claim 4, wherein at least one of the magnets has a polygonal shape when viewed in cross-section and the first and/or second notional plane is coincident with a first and/or second side of the magnet respectively.

6. A magnet assembly according to claim 3, wherein the cross-sectional shape of the first surface is defined by a line comprising one or more straight portions and/or one or more curved portions.

7. A magnet assembly according to claim 6, wherein the majority of the length of the line is substantially straight, for example wherein each magnet comprises a chamfered corner.

8. A magnet assembly according to claim 1, wherein one of the first or second pair of magnets is concentrically located within the other of the first or second pair of magnets.

9. A magnet assembly according to claim 1, wherein each magnet is a permanent magnet, for example a magnet comprising Neodymium (NdFeB), Samarium-cobalt (SmCo), and/or hard ferrites, for example ceramic materials, for example Strontium ferrite (SrFeO) and/or Barium ferrite (BaFeO).

10. A magnet assembly according to claim 1, wherein a spacer is located between the magnets of the first pair and/or the second pair.

11. A magnet assembly according to claim 10, wherein the or each spacer comprises thermally conductive material such that the spacer conducts heat away from the magnets.

12. A magnet assembly according to claim 11, wherein the or each spacer is in thermal communication with a heat sink.

13. A drive unit including a magnet assembly in accordance with claim 1, the drive unit comprising a diaphragm connected to a voice coil located in the voice coil gap.

14. A loudspeaker including a magnet assembly in accordance with claim 1.

15. A method of manufacturing an ironless magnet assembly for a loudspeaker, the method comprising:
arranging a plurality of magnets to provide
a first pair of magnets wherein the force generated between the poles of the magnets acts to repel the magnets from each other;
a second pair of magnets where the force generated between the poles of the magnets acts to repel the magnets from each other; and
wherein the first and second pair of magnets define a voice coil gap therebetween so that the force generated between the poles of the first and second pairs acts to attract the magnets to each other.

16. A method according to claim 15, wherein the step of arranging the second pair of magnets comprises placing the magnets of the second pair either side of a spacer.

17. A method according to claim 15, wherein the step(s) of arranging the first and/or second pair of magnets comprises bonding the magnets together, for example using an adhesive.

18. A method according to claim 15, wherein the method comprises shaping each magnet to provide a first surface and arranging each magnet such that the first surfaces of the magnets together define an enlarged region of the voice coil gap.

19. A method according to claim 18, wherein the step of shaping each magnet comprises sintering, for example laser sintering, a powder to form a magnet.

20. A method according to claim 18, wherein the step of shaping each magnet comprises removing material from a magnet to produce a first surface.

21. A magnet assembly for a loudspeaker comprising
two pairs of magnets, each magnet of each pair having a north pole and a south pole, a first pair of magnets being arranged with the north poles of the magnets of that pair facing each other and a second pair of magnets being arranged with the south poles of the magnets of that pair facing each other;
the first pair of magnets being located opposite the second pair of magnets to define a voice coil gap therebetween with each north pole of the first pair being located opposite a south pole of the second pair across the voice coil gap;
each magnet comprises a first surface that is neither parallel nor perpendicular to a longitudinal axis of the voice coil gap, the first surfaces of the magnets together defining an enlarged region of the voice coil gap; and wherein for each magnet,
a first notional plane may be defined that faces the opposing magnet of the other pair; and
a second notional plane may be defined that faces the other magnet of the pair;
and
the first surface extends between the first and second notional planes thereby defining the enlarged region of the voice coil gap.

22. (canceled)

23. A loudspeaker including a drive unit in accordance with claim 13.
